(19) United States
(12) Patent Application Publication
(10) Pub. No.: US 2003/0061093 A1
(43) Pub. Date: Mar. 27, 2003

(54) System for rewarding customers of financial services providers

(76) Inventor: Donald L. Todd, Prior Lake, MN (US)

Correspondence Address: PATENT DEPARTMENT, LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 09/957,044

(22) Filed: Sep. 21, 2001

(51) Int. Cl. G06F 17/60

(52) U.S. Cl. 705/14; 705/35

(57) ABSTRACT

A system is provided for use by a financial institution to monitor transactions completed by users of financial services offered by the institution, and to reward users based on the completed transactions. The system includes at least one central processing unit (CPU) with a memory for storing user records, account records that track transactions of individual users, and reward records that accumulate points or otherwise reflect accumulated value, based on the transactions. The CPU also contains software to generate a reward value based on each transaction. The reward value is based in part on the transaction amount, but also can take into account the location and timing of the transaction, the type of transaction, accumulated reward value and accumulated transaction amounts.

### BACKGROUND OF THE INVENTION

The present invention relates to systems and processes for using incentives to encourage use of financial services provided by banks or other financial institutions, typically through use of credit cards or debit cards.

Since their inception, credit cards and debit cards have played an ever-increasing role in both personal and business transactions. At many retail establishments that used to deal exclusively with purchases by cash or check, credit or debit cards now are used in the substantial majority of purchases. A rapidly increasing number of financial institutions offer the kinds of financial services available primarily through the use of debit cards and credit cards.

The result is a highly competitive industry in which providers of these financial services offer reduced interest rates on credit balance transfers and other incentives to encourage customers of competitors to switch. Alternatively or additionally, providers of these services frequently use incentives to retain the loyalty of their own customers. Typical of these programs are cash awards based on purchases and other transactions using the card during a designated period, e.g. one year. In lieu of a cash reward, points may be accumulated on behalf of the user, redeemable for products or services, e.g. frequent flyer miles. These programs usually are time-limited, in the sense that an opportunity to redeem products or services is forfeited if not exercised within a designated time period.

Another incentive is a “tiered” program in which interest rates are reduced for credit balances that exceed a certain threshold. More specialized incentives can be offered in cooperation with particular businesses, e.g. offering rewards for using certain airlines, or staying at certain hotels.

These programs, however, do not encourage long-term financial planning, or the savings and investment activity associated with such planning. Thus, they do not address a major problem in our society, namely the relative lack of savings and investments by the population at large. Too many people fail to prepare adequately for major expenses that can be reasonably anticipated, for example a college education, a down payment on a home, and retirement. Likewise, many people lack the resources to deal with a major medical expense or other unanticipated financial setback. Some individuals are unable to save, while others with the means to save and invest seem to lack the willpower to do so. In either event, the penalty for failing to plan financially can be harsh.

Longer term programs directed to savings and investments have been proposed. For example, U.S. Pat. No. 6,070,153 (Simpson) discloses a method for automatically contributing to an investment account based on credit card usage. In particular, a portion of credit card interest charges is automatically contributed to a customer's investment account. Further contributions can be based on credit card purchases. The investment account can be designated for a specific purpose, for example college or retirement.

U.S. Pat. No. 6,164,533 (Barton) describes a system for automatically contributing money to a customer's savings program based on purchases by that customer. The contribution to the savings program can be a percentage of the total purchase, the difference between the total purchase and a rounded up dollar value, or a “coupon” amount put into savings instead of given as a discount.

In a system described in U.S. Pat. No. 5,991,736 (Ferguson, et al.), customers participating in transactions involving a particular sponsor's goods or services are awarded with contributions to their retirement accounts. Yet another form of incentive, described in U.S. Pat. No. 5,297,026 (Hoffman), permits customers to invest funds and receive a higher rate of return on such funds, with the permitted amount of such funds based on purchases by the customer.

While these programs attempt to address longer term financial considerations, they have limitations that interfere with their implementation. A useful incentive system must be attractive not only to users of the financial services, but also to the financial services providers, as well as retail establishments and other entities participating at the point of the sale or other transaction. Programs that require setting up individual investment accounts, regardless of their attraction to the users, are not particularly attractive to the financial services provider faced with setting up and administering a multitude of comparatively small investment accounts. The financial services provider loses the control over, and the investment return based on, funds contributed to the individual accounts. Further, although the accounts may include a variety of types of investments, e.g. certificates of deposit, mutual funds and individual stocks, the individual accounts typically are not of sufficient size to benefit from discounted commissions and other benefits associated with trading in larger blocks.

Programs that require retailers or other point-of-transaction businesses to administer or otherwise actively participate, are understandably less attractive to such businesses. Specialized incentives, viewed favorably by providers of the particular products or services involved, frequently are seen by customers as unduly limited. Any programs that require a conscious decision on the part of the customer to save or invest, rather than spend, unfortunately miss a considerable number of participants for this reason alone. On the other hand, present-day incentive programs are not equipped to deal with the desire of individuals to assist others close to them, e.g. close friends or members of the family.

Therefore, it is an object of the present invention to provide a system for rewarding users of financial services in a manner that promotes savings without requiring a financial services provider to administer multiple individual investment accounts.

Another object of the invention is to provide, in a system that rewards users of financial services based on transactions completed through a financial services provider, a means for one user of the services to transfer value for the direct benefit of another one of the users.

A further object is to provide a system for rewarding users of financial services that imposes virtually no limit on the nature of transactions eligible for rewards, and is convenient for the retail business or other entity operating the point of the sale or other transaction.

Yet another object is to provide a system by which users are able to accumulate substantial value over a long term, simply by completing purchases and other transactions typically not associated with savings and investments.

### SUMMARY OF THE INVENTION

To achieve these and other objects, there is provided a process for rewarding users of services provided by a financial services provider, including the following steps:

a. maintaining user information including a plurality of user records, each associated with and identifying one of a plurality of individuals approved by a financial services provider for using services of the financial services provider to complete transactions;

b. maintaining account information including a plurality of account records individually associated with accounts of the users, each account record including information relating to transactions completed through the associated account;

c. maintaining reward information including a plurality of reward records, each associated with one of the accounts and indicating an accumulated reward value based in part on transactions completed through the associated account;

d. monitoring transaction information including, for each of a plurality of transactions, the transaction amount and the associated account;

e. monitoring reward transfer information including, for each of a plurality of reward transfer requests, a transferor account, a transferee account and an amount of accumulated reward value to be transferred;

f. dynamically storing the transaction information to maintain currency of the account records, processing the transaction information to generate reward values individually associated with the transactions, and dynamically storing the reward values to maintain currency of the reward records; and

g. dynamically storing the reward transfer information to maintain currency of the reward records.

The user information, account information and reward information can be maintained in a single central processing unit (CPU). Alternatively, this information may be maintained within a network that includes a CPU or several CPUs sharing information.

Preferably, monitoring the transaction information comprises maintaining couplings to a plurality of remote point-of-transaction terminals, e.g. point-of-sale terminals at retail establishments. A user presents a debit or a credit card to the retailer. Information from the card, specifically the account number, can be provided to the CPU, whereupon a prospective transaction is approved or denied, based on information in the CPU regarding the cardholder's eligibility. Approval of the transaction can trigger an updating of the cardholder's account with the transaction, process the transaction according to an algorithm to generate a reward value based at least in part on the amount of the transaction, and to add the reward value to a record of rewards maintained for that cardholder.

Advantageously, generating each reward value comprises assigning a number based in part on the monetary amount of the associated transaction. Further factors can contribute to determining the number, e.g. the location of the transaction, the timing of the transaction, and an accumulated reward value in the associated reward record. More particularly, purchases at a certain store or retail chain may be subject to a promotion in which more than the usual number of “points” is awarded per dollar of sales. An increased award may arise from a credit balance or aggregate amount of purchases exceeding a threshold for a given time period, e.g. each month.

Different types of transactions may be distinguished and treated differently according to the present system and process. The types of transactions can include purchases of goods and services, a cash advance, a major cash advance such as a mortgage or education loan, the transfer of a credit balance from a competing financial services institution, and a direct purchase of credits or other additional value for a cardholder's reward account.

Each of these types of transactions can be subject to a different algorithm for determining the reward value based on the monetary amount of the transaction.

Regardless of the nature of the transactions involved, each cardholder, or more generally each individual who uses services of the financial services provider to complete transactions, accumulates value as indicated by a number of points or credits in his or her reward record. The accumulation of value in multiple reward records, as opposed to an accumulation of value by adding money periodically to multiple investment accounts, provides a significant advantage to the financial services provider, and ultimately to the customer. The direct advantage to the provider lies in eliminating the need to set up and administer multiple individual investment accounts. Further, the financial services provider retains use of the money represented by the accumulated value until the money is withdrawn or otherwise used by the customers. Also, because the financial services provider can administer the funds as a single account representing the value accumulated in multiple accounts, the provider can pursue the better returns often available only on significantly larger investments.

Beyond their utility as direct benefits to the financial services provider, these benefits enable the financial services provider to more effectively compete in terms of direct benefits to its customers, e.g. lower interest rates on credit balances or increased rewards for transactions of a given amount.

Another advantage of the process and accompanying system is the lack of additional requirements imposed upon the retail establishments or other point-of-transaction entities. Such entities are required to transmit the account number and amount of a proposed transaction to the financial services provider. This, however, is no more than what is required in the absence of the system.

For individuals who find saving and investing difficult, the process affords a significant advantage in that the value represented by the user's reward record increases automatically with each transaction. Nothing is required of the user, other than completing the transactions and properly maintaining the account, by making required payments in a timely fashion.

According to another aspect of the invention, there is provided a system for rewarding users of financial services based on transactions completed through a financial services provider. The system includes a memory having a user sector for storing user information including a plurality of user records. Each user record is associated with and identifies one of a plurality of individuals approved by the financial services provider to use services of the financial services provider to complete transactions. The memory further has an account sector for storing account information including a plurality of account records individually associated with accounts of the individuals. Each account record includes information relating to transactions completed through the associated account. The memory further has a reward sector for storing reward information including a plurality of reward records. Each reward record is associated with one of the accounts and indicates an accumulated reward value based at least in part on transactions completed through the associated account. An input channel is provided to receive transaction information including, for each of a plurality of transactions, a transaction amount and the associated account. The input channel further is adapted to receive user information, and reward transfer information including, for each of a plurality of reward transfer requests, a transferor account, a transferee account, and an amount of accumulated reward value to be transferred. The input channel is operatively associated with the memory to transmit the transaction information to the account sector to update the associated account record, to transmit the user information to the user sector to update the associated user record, and to transmit the reward transfer information to the reward sector to update the reward records associated with the respective transferor account and transferee account. An information processor is operatively associated with the input channel and the memory. The information processor is adapted to receive the transaction information, generate a reward value associated with each transaction based at least in part on the transaction information, and transmit the reward value to the reward sector to update the associated reward record. The system further includes an image generator and an information management component operatively associated with the image generator, and the memory, adapted to cause the image generator to produce records based on selected user records, selected account records and selected reward records.

Thus in accordance with the present invention, a process and system are provided for rewarding customers of a financial services provider based on transactions completed using services of the financial services provider. Value is accumulated on behalf of each user, without requiring the financial services provider to manage multiple separate investment accounts. Through transfer requests, each customer is able to use all or a portion of the accumulated value in an account for the benefit of another customer.

### IN THE DRAWINGS

For a further understanding of the above and other features and advantages, reference is made to the following detailed description and to the drawings, in which:

FIG. 1 is a schematic view of a system for monitoring transactions completed by customers of a financial services provider, and maintaining reward records reflecting value awarded to the customers based on the transactions;

FIG. 2 is a schematic view of a central processing station of the system;

FIG. 3 illustrates a user record typical of records stored in the system to identify users of the financial services;

FIG. 4 illustrates a transaction entry typical of records provided to the processing station to summarize transactions completed by users of the financial services;

FIG. 5 illustrates an account record typical of the records maintained in the system regarding the transactions attributed to a particular account;

FIG. 6 illustrates a reward record typical of the records generated and maintained within the system concerning value attributed to respective accounts as a result of transactions completed through those accounts;

FIG. 7 illustrates a transfer request used to effect a transfer of value from one reward record to another;

FIG. 8 is a block diagram illustrating the interaction among several memory sectors and an information processing module at the central processing station;

FIG. 9 is a block diagram illustrating interaction among the memory sectors and information processing module according to an alternative embodiment of the present invention; and

FIG. 10 is a schematic illustration of an alternative embodiment network for rewarding users of financial services based on transactions completed through a financial services provider.

### DETAILED DESCRIPTION OF THE PREFERRED EMBODIMENTS

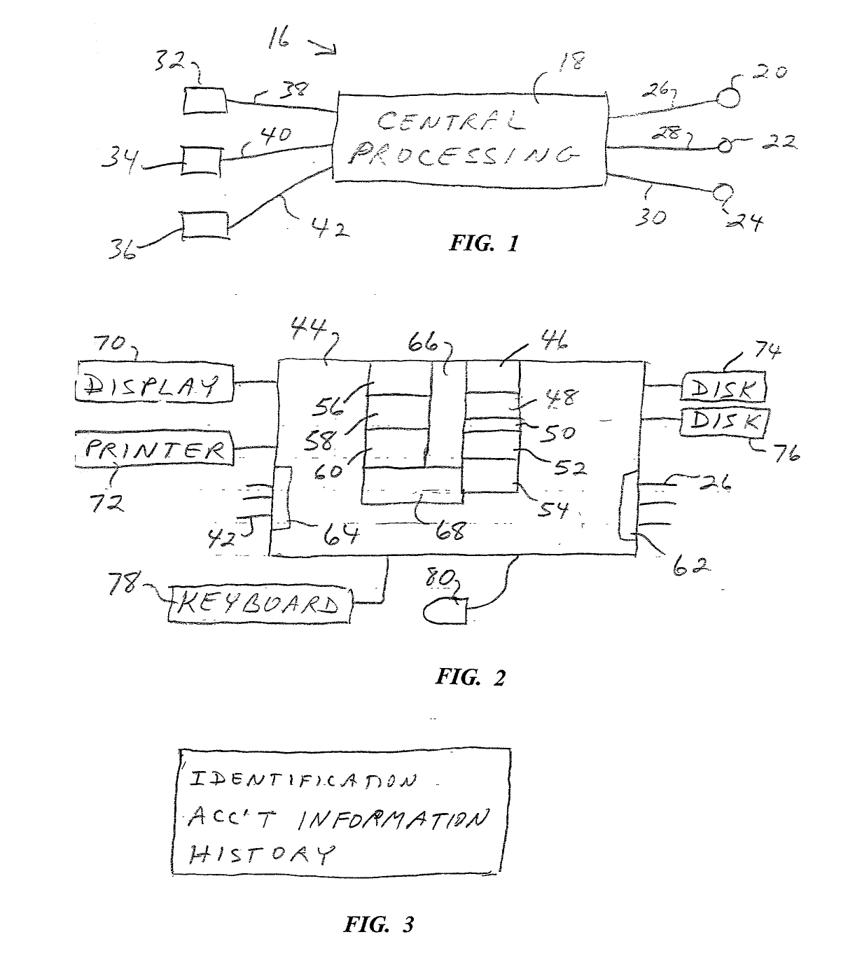

Turning now to the drawings, there is shown in FIG. 1 a system 16 for monitoring transactions completed by users of a financial services provider, typically a bank or other financial institution. Along with tracking the transactions, the system is configured to reward users of the financial services, by incrementally adding value to each account each time a user, i.e., a customer of the financial institution, uses the financial services to complete an approved transaction.

System 16 includes a central processing station 18. A plurality of user terminals, three of which are shown at 20, 22 and 24, are communicatively linked to the central processing station by data transmission pathways 26, 28 and 30, respectively. Typically the user terminals are personal computers. While these terminals and pathways facilitate communication between users and the financial institution operating the central processing station, system 16 also accommodates traditional non-electronic communication, e.g., monthly statements and other mailings.

A plurality of point-of-transaction terminals 32, 34 and 36 are communicatively coupled to the central processing station through respective data transmission pathways 38, 40 and 42. A variety of types of point-of-transaction terminals are employed, depending in part on the type of location. For example, terminal 32 is a point-of-sale terminal at a retail sales location. Terminal 34 is a telephone adapted to communicate with the central processing station whenever a user completes a telephone call using a card issued by the financial institution. Terminal 36 is an ATM or “cash” machine, from which customers of the financial institution can use their cards to make cash withdrawals.

The financial institution operates the central processing station to provide information to potential and existing customers, approve individuals applying to use the financial services, approve and monitor transactions by approved users, accumulate transaction information used in periodically billing users of the services, and accumulate value on behalf of each customer based on transactions completed by that customer using the financial services.

To this end, system 16 employs a central processing unit (CPU) 44. The CPU contains a memory for storing information concerning users and transactions, and computer programs that perform operations on the information as necessary and useful in monitoring the transactions completed by customers, and value accumulated on behalf of customers. The memory includes sectors for storing different types of information, including a general information sector 46 for storing information of interest to actual and potential customers of the financial institution, e.g., credit card applications, descriptions of new financial services and changes in existing services, and periodic newsletters.

A user information sector 48 stores multiple user records, each record pertaining to a different one of the users and containing user-identifying information. An application sector 50 stores similar information in the form of multiple applicant records. Storage in the applicant sector is temporary, pending either denial of the application or transfer of the applicant record to the user sector as one of the user records.

Sectors of the memory that store financial information include an account sector 52 for storing multiple account records. Records of individual transactions completed under a given account are accumulated in the account record associated with that account. Financial information also is maintained in a reward sector 54, which stores multiple reward records. Each reward record is associated with one of the account records, and stores an accumulated value. The accumulated value is based on transactions completed in the associated account, and is adjusted incrementally with each transaction.

System 16 accommodates transfers of accumulated value from one account to another. To this end, each reward record also includes information regarding such value transfers, typically including a credit entry to the transferee reward record and a corresponding debit entry to the transferor reward record.

Information in sectors 48, 50, 52, and 54 is restricted, in the sense that each account record and reward record is available to the user of the associated account but not to other users, accessible for example through a password. The information in individual account records and reward records also is available for use by the financial institution on a limited basis, depending on applicable laws and the agreement between the user and the financial institution. Also, information from the account sector and the reward sector is maintained in the aggregate in an aggregate account sector 56 and an aggregate reward sector 58, respectively. Sectors 56 and 58 are used by the financial institution to monitor the total value accumulation, i.e., the total value added to all reward records, as a function of the accumulated transactions in all accounts. The institution also uses sector 58 to determine the extent of funds to be set aside or investments dedicated to cover the accumulated value in the reward accounts.

A point-of-transaction memory sector 60 is used to maintain individual records of stores and other businesses, ATM machines, telephones, and other point-of-transaction locations reflecting agreements with the financial institution governing providing products or services to customers of the financial institution.

CPU 44 further includes I/O ports 62 for receiving information from user terminals and providing information to the user terminals, and I/O ports 64 for receiving information from the point-of-transaction terminals and providing information to these terminals.

Also residing in CPU 44, as indicated at 66, are computer programs coupled to the sectors of the memory through internal data transmission pathways. The programs are used to perform various operations on the information stored in the memory. These operations include comparing applicant records with approval criteria and generating results used by the financial institution in determining whether to accept or reject applications. Related programs compare user records and account records with eligibility criteria. Further computer programs are provided for applying algorithms to transaction information, thereby to determine the appropriate values added to given reward records based on the associated transactions.

An image generator 68 is operatively coupled to the memory for generating textual images based on the information stored in the memory. The images may be viewed on a video display terminal 70 coupled to the CPU, and also can be used to generate “hard copy” through a printer 72 coupled to the CPU.

Auxiliary memory can be provided for storing information processed by CPU 44, e.g., disk drives 74 and 76. Other peripheral components include the video display terminal, the printer, a keyboard 78 for entering data into the CPU, and a cursor control 80.

FIG. 3 illustrates one of the user records stored in user information sector 48. The information field labeled “Identification” includes the user's name, address and telephone number, and may include further identifiers such as the user's tax identification (e.g. social security) number, birth date or driver's license number. The field labeled “Account Information” identifies the account (or accounts) held by a customer. The “History” field contains information about the individual's usage of the account or accounts, such as when such usage began and an indication of frequency and extent of usage.

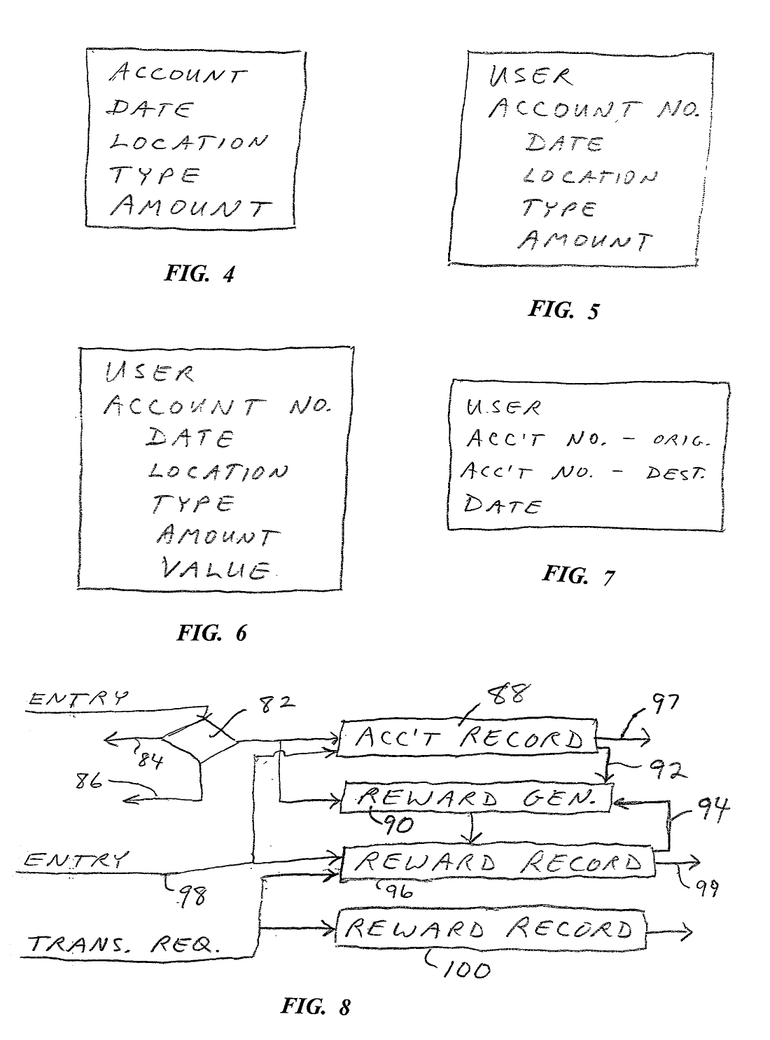

FIG. 4 illustrates one of the transaction entries generated within CPU 44 based on information received from one of the point-of-transaction terminals. The information from several transaction entries is accumulated in the account record associated with the transactions, and provided to aggregate account sector 56.

The transaction entry includes separate fields for identifying the amount of the transaction, the transaction date, and the associated account. The field labeled “Type” identifies one of several possible kinds of transactions. Typically, the most common transaction type is a purchase of goods or services. This transaction type may be identified further as a credit card purchase, a debit card purchase, or a purchase by check. Another type of transaction is a cash advance, which may further be categorized as either a routine advance of a relatively small amount for a short term, or a long-term cash advance, such as a second mortgage or a college education loan.

Another transaction type is a credit balance transfer, in which an amount owed to another financial services provider, e.g. through use of a credit card, is transferred to the financial institution operating the system. Yet another transaction type is a direct purchase of value, to be added to a particular account. Users may purchase such value for addition to their individual accounts. Retail businesses and other point-of-transaction operators may purchase such value for promotional purposes, to encourage users to complete transactions at certain retail outlets in return for “bonus” value added to their accounts.

The “Location” field identifies the particular store, ATM location, etc.

All records of transactions completed under a particular account are stored in the associated account record. As seen in FIG. 5, the account record includes fields identifying the user and the account number, along with category headings under which the information from the transaction entries is accumulated. The account record also can include a total amount for the accumulated transactions, typically over one month or other predetermined cycle. The account record can include subtotals for transactions of different types.

The “Status” field contains information concerning the user's eligibility for using services of the financial institution. The information may relate simply “eligible” or “ineligible” status, or in addition, may relate a restricted status limiting the user to certain types of transactions or a certain cumulative transaction amount for a given cycle.

FIG. 6 shows a reward record typical of the records stored in reward sector 54. Single fields identify the user and the associated account. The reward record also includes categories for organizing information from multiple transaction records as to date, location, type, and amount, as well as the incremental value associated with each transaction. The reward record further includes information regarding accumulated value, including the total incremental value accumulated over a month or other predetermined cycle, and the total value accumulated (and not used) over the life of the account. The renewal record also may contain entries regarding changes in the accumulated value for reasons other than transactions, e.g. dedications arising from withdrawals of funds, or penalties for late payment, non payment or other default conditions.

Further in accordance with the present invention, a user or account holder can transfer accumulated value to another account. The holder of a “transferor” account can transfer value to a “transferee” account by providing a transfer request to the financial institution, either electronically from a user terminal to the central processing station, or by mail or other non-electronic delivery. A transfer request, as shown in FIG. 7, includes fields for identifying the user or transferor, the transferor account number, the transferee account number, the date and the amount to be transferred. A personal identification number (PIN) or other security feature is included in transfer requests provided electronically, to counteract the risk of erroneous or fraudulent transfer attempts.

FIG. 8 illustrates the manner in which transaction entries and transfer requests are processed in CPU 44 to update the account records and reward records.

Transaction information is provided to the central processing station in the form of multiple transaction entries like that shown in FIG. 4, each representing an individual transaction. The symbol at 82 represents an approval stage at which a transaction entry received from one of the point-of-transaction terminals is evaluated against customary approval criteria, for example, to determine whether it exceeds an approved maximum amount, or would raise an accumulated transaction total beyond a permitted maximum for the current cycle. The approval stage further includes checking the eligibility of the account, both generally and with respect to the type of transaction involved.

If the proposed transaction fails to meet the criteria, the transaction is refused and a message regarding refusal returned to the point-of-transaction terminal, as indicated at 84.

When the proposed transaction is approved, a message is returned to the point-of-transaction terminal confirming approval, as indicated at 86. The transaction entry is provided as an input to account sector 52, in particular to an account record 88 associated with the transaction, to update that account record.

The transaction entry further is provided to a reward generator 90 including computer software adapted to process the transaction entry according to predetermined algorithms and additional inputs, thus to generate a reward value resulting from the transaction.

Although it is possible to determine the reward amount based solely on the amount of a transaction, further information preferably is taken into account. The transaction location and transaction type are provided to the reward generator in addition to the transaction amount. An input from associated account record 88, indicated at 92, provides an accumulated total amount for transactions occurring during a current billing cycle or other predetermined time. Other selected information from the account record may be provided via input 92. An input 94 to the reward generator from an associated reward record 96 provides a total reward value accumulated during the current billing cycle or other predetermined time.

Based on these inputs, reward generator 90 processes the transaction amount according to predetermined algorithms, and generates the resulting reward value. Preferably the reward value is represented by a number of points, provided to reward record 96 as an addition to the points already accumulated.

The number of points is based in part on the amount of the transaction, with further algorithms adapted to take other factors into account, as follows:

1. Transaction Type: the algorithms may determine a reward of one point per $100 in amount of a credit card or debit card purchase, while determining a reward of a fraction of a point for each $100 in amount of a cash advance or balance transfer.

2. Transaction Location: an additional fraction of a point can be rewarded as a bonus for credit or debit card purchases at particular locations, e.g. stores of a retail chain.

3. Transaction Timing: an additional fractional point per $100 amount may be awarded for transactions completed during specified time periods.

4. Accumulated Balance: additional fractional points per $100 amount in credit or debit card purchases may be awarded when an accumulated transaction amount for a current billing cycle or other designated time period exceeds a threshold, or when accumulated points in the associated reward record exceed a predetermined threshold.

A line 98 indicates an alternative under which a transaction entry is provided to account record 88 and reward record 96 directly, bypassing reward generator 90. This alternative applies to one type of transaction, namely the direct purchase of reward points. Transfer requests likewise bypass reward generator 90. A transfer request, originating with the same account associated with the transactions in FIG. 8, is provided as a debit to reward account 96 (associated with the transferor account), and as a credit to a reward record 100, i.e. the reward record associated with the transferee account.

Arrows 97 and 99 indicate, respectively, the provision of information reflecting the updated account record and updated reward record to the account holder. This information can be provided periodically, e.g. in the monthly statement. Alternatively, the account holder may gain access through one of the user terminals coupled to central processing station 18. The terminal may be coupled by a dedicated data transmission line or via the internet. In either event, access to the information requires a personal identification number or other security feature.

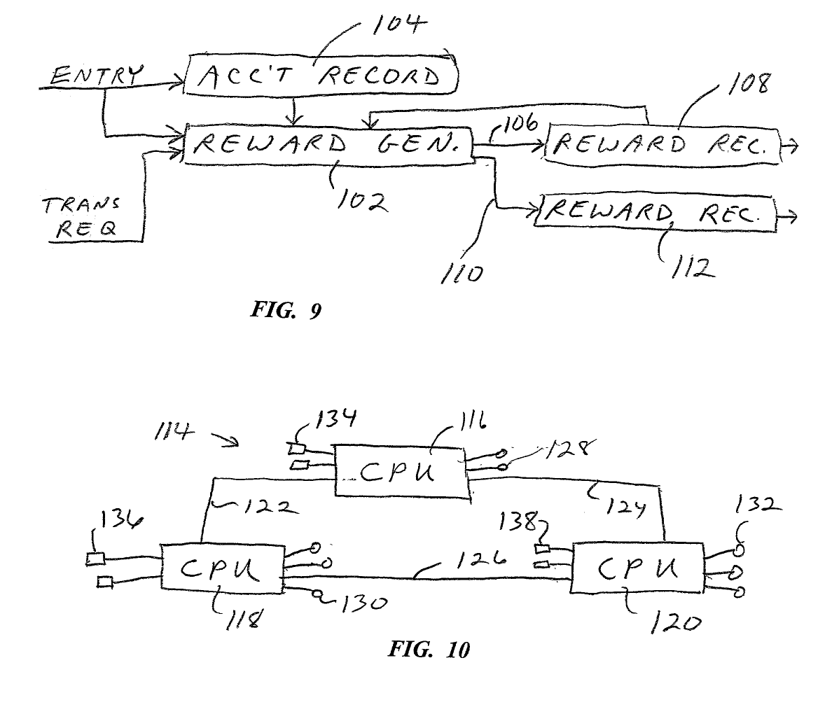

FIG. 9 illustrates an alternative approach under which all transaction entries and transfer requests are provided as inputs to a reward generator 102. The transaction requests also are provided to an associated account record 104, as before. Under this option, reward generator 102 can be configured to determine an added bonus, for example, five percent, for the direct purchase of reward points. Likewise, the reward generator can be configured to determine a bonus for a transfer of reward points from one reward record to another, whereby an input 106 to a transferor reward record 108 would deduct the total of points corresponding to the transfer request, while an input 110 to a transferee reward record 112 would credit this reward record with the requested amount augmented by a bonus under limited circumstances. For example, the transferee account might qualify for a bonus only if dedicated to a specific purpose such as a college education fund. and the bonus might be limited to a particular time period.

FIG. 10 illustrates an alternative embodiment in the form of a network 114 operated by a financial institution or other financial services provider, for monitoring transactions completed by users of the financial services, and for rewarding users based on completed transactions. Network 114 incorporates several processing stations represented by CPUs 116, 118 and 120, although the network may have additional processing stations. The processing stations are linked by data transmission pathways 122, 124 and 126 to facilitate information exchange. User terminals are communicatedly linked to each of the processing stations, as indicated at 128, 130 and 132, respectively. Point-of-transaction terminals are similarly coupled to the processing stations, as indicated respectively at 134, 136 and 138.

Each of CPUs 116, 118 and 120 includes a memory with sectors as described above for storing user records, account records and reward records, and further incorporates information management and processing programs as discussed above in connection with CPU 44. Alternatively, one of CPUs 116, 118 and 120 can be configured as a “primary” CPU containing the memory sectors, information management programs and information processing programs, with the other CPUs adapted to accept transaction entries and transfer requests, then forward the same to the primary CPU for processing. In either event, a financial institution having several locations for providing financial services, remote from one another, can advantageously use network 114.

Systems and networks operated according to the present invention afford advantages to financial institutions and other financial services providers, users of the financial services, and businesses and other administrators of locations where transactions are completed. For users, the system facilitates use of the financial services, free of restrictions as to the types of goods and services purchased, and free of restrictions governing use of the value accumulated in the account. The transferability of value from one account to another, typically by transferring points from one reward record to another, allows groups to accumulate value for the benefit of an individual user if they are so inclined. For example, a family can accumulate value for the benefit of a college tuition fund or retirement fund for one of the family members. For users who are disinclined to save, an additional benefit is that transactions ordinarily having nothing to do with saving money are used to accumulate value in the user's account.

To the financial institution, the primary advantage of the system or network is the capacity to accumulate value on behalf of multiple users, without setting up and administering multiple individual savings or investment accounts. Instead, the aggregate accumulated value of all accounts, represented by the aggregate total of points in all reward records, can be supported by a single investment account administered by the financial services provider. The value of the single account can equal or exceed the value represented by all individual accounts. Alternatively, a single account with a lower balance may be sufficient to support the aggregate value accumulated in individual accounts, based on the service provider's experience with user withdrawals. In either event, the single account has a value orders of magnitude greater than the value represented by any of the individual accounts, enabling the financial services provider to pursue improved returns and other benefits available through larger investments. These advantages accrue directly to the financial services provider, but also can indirectly benefit users by enabling the provider to extend lower interest rates or other cost reductions.

Finally, systems and networks according to the present invention are advantageous to retail establishments and other entities that provide locations where users of the financial services can complete transactions. There is no requirement beyond the traditional need to transmit an account number and transaction amount to the financial institution for approval. As an added benefit, businesses may purchase reward points or cooperate with the financial institution to provide for bonus points to users who complete transactions at designated locations.

What is claimed is:

1. A system for rewarding users of financial services based on transactions completed through a financial services provider, including:
a memory having a user sector for storing user information including a plurality of user records, each associated with and identifying one of a plurality of individuals approved by a financial services provider to use services of the financial services provider to complete transactions;
the memory further having an account sector for storing account information including a plurality of account records individually associated with accounts of the individuals, each account record including transaction information relating to transactions completed through the associated account;
the memory further having a reward sector for storing reward information including a plurality of reward records, each associated with one of the accounts and indicating an accumulated reward value based at least in part on transactions completed through the associated account;
an input channel adapted to receive transaction information including, for each of a plurality of transactions, a transaction amount and the associated account; user information; and reward transfer information including, for each of a plurality of reward transfer requests, a transferor account, a transferee account, and an amount of accumulated reward value to be transferred;
wherein the input channel is operatively associated with the memory to transmit the transaction information to the account sector to update the associated account record, to transmit the user information to the user sector to update the associated user record, and to transmit the reward transfer information to the reward sector to update the reward records associated with the respective transferor account and transferee account;
an information processor operatively associated with the input channel and the memory, adapted to receive the transaction information, generate a reward value associated with each transaction based at least in part on the transaction information, and transmit the reward value to the reward sector to update the associated reward record;
an image generator; and
an information management component operatively associated with the image generator and the memory, adapted to cause the image generator to produce reports based on selected user records, selected account records and selected reward records.

2. The system of claim 1 wherein:
the input channel is coupled to the reward sector to transmit the reward transfer information directly to the reward sector.

3. The system of claim 1 wherein:
the input channel is coupled to the reward sector through the information processor, whereby the reward transfer information is transmitted to the reward sector via the information processor.

4. The system of claim 1 wherein:
the input channel and the memory reside in a central processing unit, and the information processor comprises a computer program resident in the central processing unit.

5. The system of claim 1 wherein:
the memory resides within a network incorporating a central processing unit, and the information processor comprises a computer program resident in the central processing unit.

6. The system of claim 1 wherein:
the input channel is adapted for coupling to a plurality of remote point-of-transaction terminals to facilitate the receipt of the transaction information.

7. The system of claim 6 wherein:
the memory is adapted for storing status information concerning eligibility of the individuals to use services of the financial services provider to complete transactions.

8. The system of claim 7 wherein:
the status information includes a status field in each of the account records, indicating either (i) an eligible status based on good standing; or (ii) an ineligible status based on a default condition.

9. The system of claim 8 further including:
an output channel coupled to the memory and adapted for coupling to said remote point-of-transaction terminals to facilitate transmission of the status information to the point-of-transaction terminals.

10. The system of claim 9 wherein:
the transaction information includes information about prospective transactions transmitted from the point-of-transaction terminals to the input channel; and
the information processor further is adapted to receive the information regarding each prospective transaction from the input channel, gain access to the associated account record, and either generate an approval message responsive to reading an eligible status, or generate a denial message responsive to reading an ineligible status.

11. The system of claim 10 wherein:
the information processor further is adapted to transmit the information regarding each prospective transaction to the account sector and transmit the corresponding reward amount to the reward sector, responsive to reading an eligible status.

12. The system of claim 1 wherein:
the input channel is adapted for coupling to a plurality of remote user terminals to facilitate receipt of the user information from users and prospective users.

13. The system of claim 12 further including:
an output channel coupled to the memory and to the remote user terminals, to facilitate transmission of information to the users and the prospective users.

14. The system of claim 1 wherein:
the reward sector includes an aggregate reward record indicating a total accumulated reward value of the reward records combined.

15. The system of claim 1 wherein:
the information processor further is adapted to generate the reward value associated with each transaction as a number based at least in part on the monetary amount of the transaction.

16. The system of claim 15 wherein:
said number further is generated based on an additional factor selected from the group including: a location of the transaction; a timing of the transaction; an accumulated amount in the account record associated with the transaction; and the accumulated reward value in the reward record associated with the transaction.

17. The system of claim 15 wherein:
the information processor further is adapted to identify each of the transactions as one of a plurality of different transaction types, and to generate said number based in part on the transaction type.

18. A process for rewarding users of services provided by a financial services provider, including:
maintaining user information including a plurality of user records, each associated with and identifying one of a plurality of individuals approved by a financial services provider for using services of the financial services provider to complete transactions;
maintaining account information including a plurality of account records individually associated with accounts of the users, each account record including information relating to transactions completed through the associated account;
maintaining reward information including a plurality of reward records, each associated with one of the accounts and indicating an accumulated reward value based at least in part on transactions completed through the associated account;
monitoring transaction information including, for each of a plurality of transactions, the transaction amount and the associated account;
monitoring reward transfer information including, for each of a plurality of reward transfer requests, a transferor account, a transferee account and an amount of accumulated reward value to be transferred;
dynamically storing the transaction information to maintain currency of the account records, processing the transaction information to generate reward values individually associated with the transactions, and dynamically storing the reward values to maintain currency of the reward records; and
dynamically storing the reward transfer information to maintain currency of the reward records.

19. The process of claim 18 further including:
generating textual images based on the user information, the account information, the transaction information and the reward information.

20. The process of claim 18 wherein:
maintaining the user information, account information and reward information comprises storing said information in a central processing unit.

21. The process of claim 18 wherein:
maintaining the user information, account information and reward information comprises storing said information within a network that includes a central processing unit.

22. The process of claim 18 wherein:
said monitoring the transaction information comprises maintaining couplings to a plurality of remote point-of-transaction terminals.

23. The process of claim 18 wherein:
said dynamically storing the reward transfer information comprises storing said information directly to each of the reward records corresponding to the transferor account and transferee account.

24. The process of claim 18 wherein:
dynamically storing the reward transfer information comprises providing the transaction requests to an information processor, then providing an output of the information processor to the reward records corresponding to the transferor account and transferee account.

25. The process of claim 18 wherein:
maintaining the reward information comprises maintaining an aggregate reward record indicating a total accumulated reward value of the reward records combined.

26. The process of claim 18 wherein:
generating each reward value comprises assigning a number based in part on the monetary amount of the associated transaction.

27. The process of claim 26 wherein:
assigning the number further is based on a factor selected from the group consisting of: location of the transaction; timing of the transaction; an accumulated amount in the associated account record; and an accumulated reward value in the associated reward record.

28. The process of claim 26 further including:
identifying each of the transactions as one of a plurality of different transaction types, and assigning the number based in part on the transaction type.

29. The process of claim 18 further including:
providing, to each of the individuals, account information and reward information from each account record and each reward record maintained for that individual.

30. The process of claim 29 wherein:
providing the information comprises a step selected from the group consisting of: sending periodic statements to that individual; and extending on-line access to the records maintained for that individual.

31. The process of claim 18 further including:
maintaining information concerning eligibility of the individuals to use services of the financial services provider to complete transactions, and using the eligibility information to either approve or deny prospective transactions.
